(19) United States
(12) Patent Application Publication
(10) Pub. No.: US 2025/0178471 A1
(43) Pub. Date: Jun. 5, 2025

(54) NON-CONTACT CHARGE CONTROL DEVICE

(71) Applicant: TOYOTA JIDOSHA KABUSHIKI KAISHA, Toyota-shi Aichi-ken (JP)

(72) Inventors: Yoshinobu SUGIYAMA, Toyota-shi Aichi-ken (JP); Koji SHIGEUCHI, Nagakute-shi Aichi-ken (JP); Masanori ISHIGAKI, Nagakute-shi Aichi-ken (JP)

(73) Assignee: TOYOTA JIDOSHA KABUSHIKI KAISHA, Toyota-shi Aichi-ken (JP)

(21) Appl. No.: 18/958,756

(22) Filed: Nov. 25, 2024

(30) Foreign Application Priority Data
Nov. 30, 2023 (JP) 2023-203368

(51) Int. Cl. B60L 53/62; B60L 53/122

(52) U.S. Cl. CPC B60L 53/62; B60L 53/122; B60L 2210/30

(57) ABSTRACT

A non-contact charging control device for controlling a power receiving device capable of non-contact charging to charge a battery by non-contact receiving power from a power transmission device, includes: a transformer of a power receiving side for receiving an AC power having a transmission frequency transmitted from a transformer of a power transmission side; a rectifier circuit for converting the AC power received by the transformer of the power receiving side into DC power and outputting the DC power to the battery; a smoothing capacitor, provided between the rectifier circuit and the battery, for smoothing a current from the rectifier circuit; a voltage sensor for detecting a voltage of the smoothing capacitor; and a controller, when an overvoltage of the smoothing capacitor is detected, reduces a voltage phase difference between the transformer of the power transmission side and the transformer of the power receiving side.

### CROSS-REFERENCE TO RELATED APPLICATION(S)

The present application claims priority to and incorporates by reference the entire contents of Japanese Patent Application No. 2023-203368 filed in Japan on Nov. 30, 2023.

### BACKGROUND

The present disclosure relates to a contactless charge control device.

For example, in Japanese Laid-open Patent Publication No. 2022-160093, by performing the operation of transmitting power while ensuring electrical insulation between the first three-phase switching circuit provided on the ground side and the second three-phase switching circuit provided on the vehicle side and the operation of boosting the voltage by a transformer with the transformer, the simplification or miniaturization of the circuit of the power converter is achieved.

### SUMMARY

There is a need for providing a non-contact charge control device capable of stopping charging at abnormal cases.

According to an embodiment, a non-contact charging control device for controlling a power receiving device capable of non-contact charging to charge a battery by non-contact receiving power from a power transmission device, includes: a transformer of a power receiving side for receiving an AC power having a transmission frequency transmitted from a transformer of a power transmission side in a non-contact manner; a rectifier circuit for converting the AC power received by the transformer of the power receiving side into DC power and outputting the DC power to the battery; a smoothing capacitor, provided between the rectifier circuit and the battery, for smoothing a current from the rectifier circuit; a voltage sensor for detecting a voltage of the smoothing capacitor; and a controller, when the voltage sensor detects an overvoltage of the smoothing capacitor, reduces a voltage phase difference between the transformer of the power transmission side and the transformer of the power receiving side.

### BRIEF DESCRIPTION OF THE DRAWINGS

FIG. 1 is a diagram schematically illustrating a configuration of a non-contact power transmission system according to a first exemplary embodiment of the present disclosure;

FIG. 2 is a main circuit configuration diagram of a non-contact power transmission system described in FIG. 1;

FIG. 3 is a diagram illustrating an equivalent circuit of a transformer according to the first embodiment of the present disclosure;

FIG. 4 is a diagram illustrating an outline of the voltage-current waveform of each part in the equivalent circuit of FIG. 3;

FIG. 5 is a diagram illustrating an outline of a conventional power control;

FIG. 6 is a diagram illustrating an outline of power control in a contactless power transmission system according to a first exemplary embodiment of the present disclosure;

FIG. 7 is a flowchart illustrating an outline of processing that is executed by a vehicle-side control device according to the first embodiment of the present disclosure;

FIG. 8 is a diagram schematically illustrating a configuration of a non-contact power transmission system according to a second exemplary embodiment of the present disclosure; and

FIG. 9 is a flowchart illustrating an outline of processing that is executed by the ground-side control device according to the second embodiment of the present disclosure.

### DETAILED DESCRIPTION

In the non-contact charging apparatus as in Japanese Laid-open Patent Publication No. 2022-160093, in the case where the ground-side inverter controls the charging power, at the time of abnormality, when releasing the vehicle-side relay connecting the battery and the transformer on the vehicle side during charging, power from the ground side is charged to the capacitor, an overvoltage. Therefore, in the non-contact charging device, when abnormal, through wireless communication, the vehicle side instructs to stop the supply of power to the ground side, due to the time required for communication, charging stop is not in time, there may be a case of failure.

Hereinafter, a non-contact charging control device according to an embodiment of the present disclosure will be described with reference to the drawings. Note that the components in the following embodiments include those which can be substituted and easily by those skilled in the art, or those which are substantially the same. Further, the drawings referred to in the following description are only schematically illustrating the shape, size, and positional relationship to the extent that the contents of the present disclosure can be understood. In other words, the present disclosure is not limited only to the shape, size, and positional relationship exemplified in each of the figures.

### First Embodiment

### Configuration of Contactless Power Transmission System

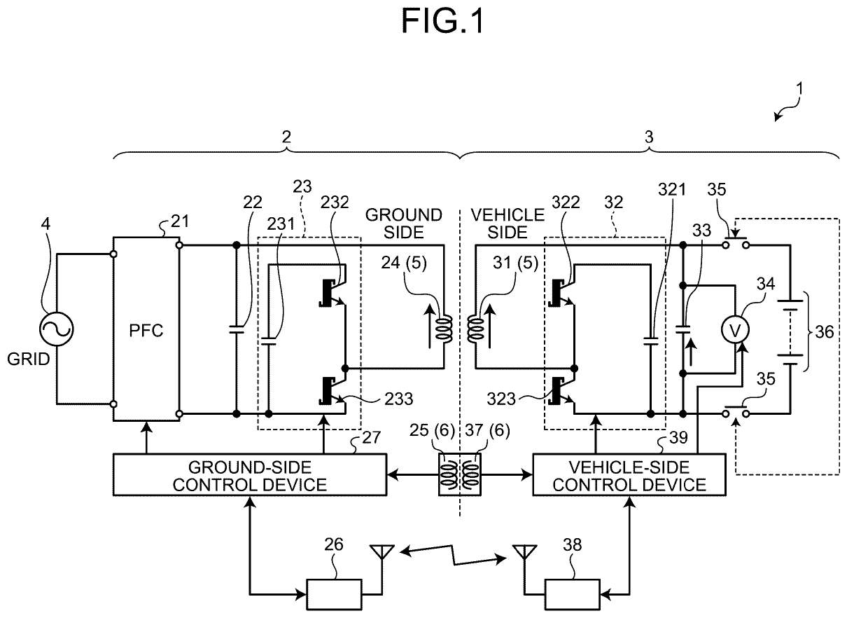

FIG. 1 is a diagram schematically illustrating the configuration of a non-contact power transmission system according to the first embodiment. The contactless power transmission system 1 illustrated in FIG. 1 includes a power transmission device 2 and a power receiving device 3 that are magnetically coupled. The non-contact power transmission system 1, the power transmission device 2 performs power transmission in a non-contact manner to the power receiving apparatus 3 by magnetic field coupling the power from the AC power source 4.

### Configuration of Power Transmission Device

First, the configuration of the power transmission device 2 is described. The power transmission device 2 is provided, for example, on the ground. The power transmission device 2 is electrically connected to the AC power source 4 (e.g., a commercial system power supply), and receives power from the AC power source 4. The power transmission device 2 includes a Power Factor Correction (PFC) circuit 21, a smoothing capacitor 22, an inverter circuit 23, a ground-side transformer 24, a ground-side synchronization signal transformer 25, a ground-side communication unit 26, and a ground-side controller 27.

The PFC circuit 21 supplies to the inverter circuit 23 converts the AC power received from the AC power source 4 into DC. Furthermore, the PFC circuit 21 is configured to improve the power factor by bringing the incoming current closer to the sine wave. The PFC circuit 21 is configured by employing a variety of known circuits. Instead of the PFC circuit 21, a rectifier that does not have a power factor improving function may be employed.

The smoothing capacitor 22 is provided between the PFC circuit 21 and the inverter circuit 23, to smooth the current from the PFC circuit 21.

The inverter circuit 23 converts the DC power inputted from PFC circuit 21 into the transmission power having a predetermined transmission frequency (AC) and transmits the power to the ground-side transformer 24. The inverter circuit 23 is at least constituted by a step-up capacitor 231, the switching element 232, and the switching element 233.

The step-up capacitor 231 has one end electrically connected to the switching element 232, the other end is electrically connected to the switching element 233.

Each of the switching element 232 and the switching element 233 is electrically connected in series. Further, the switching element 232 has one end electrically connected to the step-up capacitor 231, the other end is electrically connected to the switching element 233. Furthermore, the switching element 233 has one end electrically connected to the switching element 232, the other end is electrically connected to the step-up capacitor 231. For each of the switching element 232 and the switching element 233, an Insulated Gate Bipolar Transistor (IGBT), a Metal Oxide Semiconductor Field Effect Transistor (MOSFET) or the like is used.

The ground-side transformer 24 is a primary coil, and transmits an AC power having a transmission frequency received from the inverter circuit 23 (transmission power), from the power transmission device 2 to the power receiving device 3 through a magnetic field formed between the ground-side transformer 24 and the vehicle-side transformer 31 to be described later. That is, the ground-side transformer 24 and the vehicle-side transformer 31 is magnetically coupled to constitute a transformer 5.

The ground side synchronization signal transformer 25 is a primary coil, under the control of the ground-side controller 27, and transmits the synchronization signal for coupling with the transformer 5 input from the ground-side controller 27 to the vehicle-side synchronization signal transformer 37 to be described later. That is, the ground-side synchronizing signal transformer 25 and the vehicle-side synchronizing signal transformer 37 is magnetically coupled to constitute a synchronizing signal transformer 6.

Under the control of the ground-side controller 27, the ground-side communication unit 26 performs wireless communication with the vehicle-side communication unit 38 to be described later according to a predetermined communication standard. Here, the predetermined communication standard refers to, for example, a Bluetooth (registered trademark) and Wi-Fi, and the like. The ground-side communication unit 26 is configured by using a communication module or the like which can be transmitted in a predetermined communication standard.

The ground-side controller 27 controls each part of the power transmission device 2. The ground controller 27 is configured with a processor having hardware such as memories and a Central Processing Unit (CPU). The ground-side controller 27 controls the on-off operation of the switching element 232 and the switching element 233. Specifically, the ground-side controller 27, when switching the switching element 232 from the off state to the on state, switches the switching element 233 from the on state to the off state.

### Configuration of the Power Receiving Device

Next, the configuration of the power receiving device 3 is described. The power receiving device 3 includes a vehicle-side transformer 31, a rectifier circuit 32, a smoothing capacitor 33, a voltage sensor 34, a relay circuit 35, a battery 36, a vehicle-side synchronization signal transformer 37, a vehicle-side communication unit 38, and a vehicle-side control device 39. In the first embodiment, the power receiving device 3 functions as a non-contact charging control device.

The vehicle-side transformer 31 is a secondary coil, and contactlessly receives an AC power having a transmission frequency transmitted from the ground-side transformer 24 of the power transmission device 2 (transmission power) through a magnetic field formed between the ground-side transformer 24. The vehicle-side transformer 31 outputs the AC power received to the rectifier circuit 32.

The rectifier circuit 32 converts the AC power input from the vehicle-side transformer 31 into DC, and outputs to the battery 36. The rectifier circuit 32 is constituted by a step-up capacitor 321, the switching element 322, and the switching element 323.

The step-up capacitor 321 has one end electrically connected to the switching element 322, the other end is electrically connected to the switching element 323.

Each of the switching element 322 and the switching element 323 is electrically connected in series. Further, the switching element 322 has one end electrically connected to the step-up capacitor 321, the other end is electrically connected to the switching element 323. Furthermore, the switching element 323 has one end electrically connected to the switching element 322, the other end is electrically connected to the step-up capacitor 321. As each of the switching element 322 and the switching element 323, a IGBT or MOSFET or the like is used.

The smoothing capacitor 33 is provided between the rectifier circuit 32 and the battery 36, to smooth the current from the rectifier circuit 32.

The voltage sensor 34 detects the voltage of the smoothing capacitor 33, and outputs the detection result to the vehicle-side control device 39. The voltage sensor 34 is connected in parallel to the smoothing capacitor 33.

The relay circuit 35 is provided between the rectifier circuit 32 and the battery 36. The relay circuit 35, under the control of the vehicle-side control device 39, turned on when charging the battery 36 by the power transmission device 2 (closed state), electrically connecting the rectifier circuit 32 and the battery 36. In contrast, the relay circuit 35, under the control of the vehicle-side control device 39, turns off (open state), to electrically shut off the rectifier circuit 32 and the battery 36.

The battery 36 is configured with a rechargeable DC power source, for example, a secondary battery such as a lithium ion secondary battery or a nickel metal hydride battery. The battery 36 stores power input from the rectifier circuit 32 via the relay circuit 35. The battery 36 supplies the stored power to a driving device (not illustrated) or the like of the motor generator (not illustrated).

The vehicle-side synchronizing signal transformer 37 is a secondary coil, receives a synchronizing signal for coupling with the transformer 5 from the ground-side synchronizing signal transformer 25, and outputs the received synchronizing signal to the vehicle-side control device 39.

The vehicle-side communication unit 38 performs wireless communication with the ground-side communication unit 26 under the control of the vehicle-side control device 39 according to a predetermined communication standard. The vehicle-side communication unit 38 is configured by using a communication module or the like which can be transmitted in a predetermined communication standard.

The vehicle-side control device 39 controls each part of the power receiving device 3. The vehicle-side control device 39 is configured using a processor having hardware such as a memory—and a CPU. The vehicle-side control device 39 controls the on-off operation of the switching element 322 and the switching element 323. Further, the vehicle-side control device 39, when the voltage sensor 34 detects an overvoltage of the smoothing capacitor 33, performs control to reduce the voltage phase difference between the ground-side transformer 24 and the vehicle-side transformer 31. Specifically, the vehicle-side control device 39 sets that the voltage phase difference between the ground-side transformer 24 and the vehicle-side transformer 31 to 0. In the first embodiment, the vehicle-side control device 39 functions as a control unit.

### Main Circuit Configuration of Contactless Power Transmission System and Equivalent Circuit of the Transformer

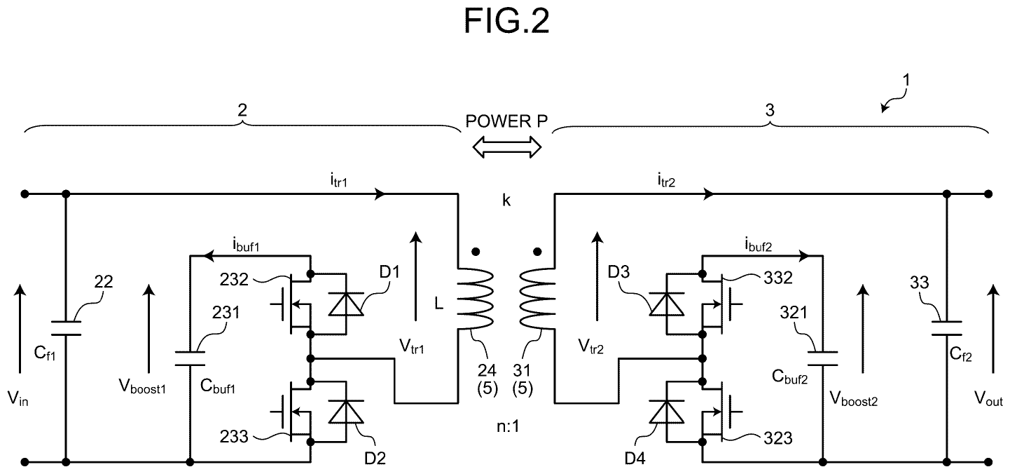

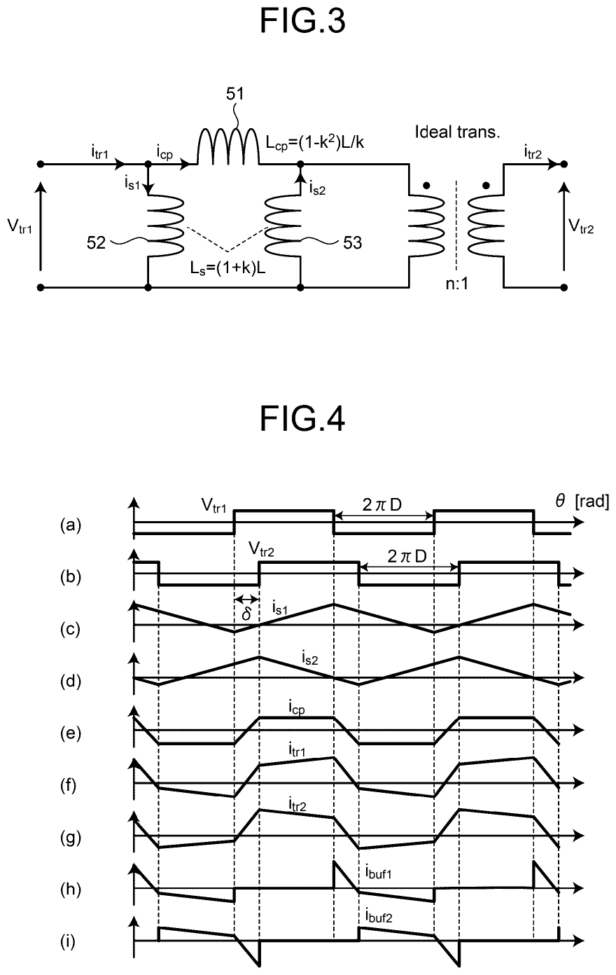

Next, the main circuit configuration of the contactless power transmission system 1 and the equivalent circuit of the transformer 5 are described. FIG. 2 is a main circuit configuration diagram of a non-contact power transmission system 1 described in FIG. 1. FIG. 3 illustrates an equivalent circuit of the transformer 5. FIG. 4 is a diagram illustrating an outline of the voltage-current waveform of each part in the equivalent circuit of FIG. 3.

As illustrated in FIGS. 2 to 3, in each of the switching element 232 and the switching element 233 of the power transmission device 2, the reflux diode D1, D2 are electrically connected in anti-parallel. Similarly, for each of the switching element 332 and the switching element 323 of the power receiving device 3, the reflux-diode D3, D4 are electrically connected in anti-parallel.

Further, the equivalent circuit illustrated in FIG. 3 includes a series inductor 51, a first shunt inductor 52, and the second shunt inductor 53. The inductance of the ground-side transformer 24 is L, when the coupling factor of the ground-side transformer 24 and the vehicle-side transformer 31 and k, the inductance Lcp of the series inductor 51 is (1−k2) L/K. Further, the inductance Ls of the first shunt inductor 52 and the second shunt inductor 53 becomes (1+k) L.

Thus, in the non-contact power transmission system 1, the switching of the switching element 232 and the switching element 233, the induced electromotive force is generated in the first shunt inductor 52. The step-up voltage Vboost1 based on the output voltage Vin of the induced electromotive force and the AC power source 4 is applied to the capacitor Cbuf1 (step-up capacitor 231). The capacitor Cbuf1 is charged by the applied voltage.

Further, in the non-contact power transmission system 1, due to the switching of the switching element 322 and the switching element 323, the induced electromotive force is generated in the second shunt inductor 53. The step-up voltage Vboost2 based on the induced electromotive force and the output voltage Vout of the battery is applied to the capacitor Cbuf2 (step-up capacitor 321). The capacitor Cbuf1 is charged by the applied voltage.

In the non-contact power transmission system 1, the power P transmitted between the transformers 5 is determined based on the duty ratio D1 of the switching element 232 and the switching element 233 of the power transmission device 2, and the duty ratio D2 of the switching element 322 and the switching element 323 of the power receiving device 3, the voltage phase difference δ of the transformer voltage of the transformer 5 consisting of the ground-side transformer 24 and the vehicle-side transformer 31. Specifically, the non-contact power transmission system 1, the power P transmitted between the transformers 5 is given as indicated in the equation (1).

$$[ Equation 1 ]$$

$$P = \frac{{nV}_{in} {V}_{out}}{ω {L}_{cp}} \frac{1}{4 {D}^{2}} δ \{ 1 - \frac{\vert δ \vert}{π} - {( 1 - 2 D )}^{2} \} \\ ( \vert δ \vert < 2 π min ( D , 1 - D ) ) \qquad ( 1 )$$

Here, the voltage current of each part in FIGS. 2 and 3 will be described. FIG. 4 is a diagram illustrating an outline of a voltage current waveform of each part in FIGS. 2 and 3. FIG. 4 illustrates the results when the duty ratio D1 and the duty ratio D2 are equal and D. The horizontal axis in FIG. 4 illustrates the phase (θ [rad]). Further, in FIG. 4 from the upper, part (a) illustrates a voltage Vtr1 appearing in the ground-side transformer 24, part (b) illustrates a voltage Vtr2 appearing in the vehicle-side transformer 31.

Further, in FIG. 4, part (c) illustrates boosted current iS1 flowing through the first shunt inductor 52, part (d) illustrated boosted current iS2 flowing through the second shunt inductor 53, and part (e) illustrates the transmission current icp flowing through the series inductor 51 is illustrated. Furthermore, part (f) illustrates the current itr1 flowing through the ground-side transformer 24, and part (g) illustrates the current itr2 flowing through the vehicle-side transformer 31. Further, part (h) illustrates the current ibuf1 flowing through the inverter circuit 23, and part (i) illustrates the current ibuf1 flowing through the rectifier circuit 32.

As illustrated in FIG. 4, in the contactless power transmission system 1, by controlling the voltage phase difference δ, it is possible to control the power transmission amount. That is, in the non-contact power transmission system 1, if the voltage phase difference δ is 0, the charging power becomes 0.

### Control of the Voltage Phase Difference δ

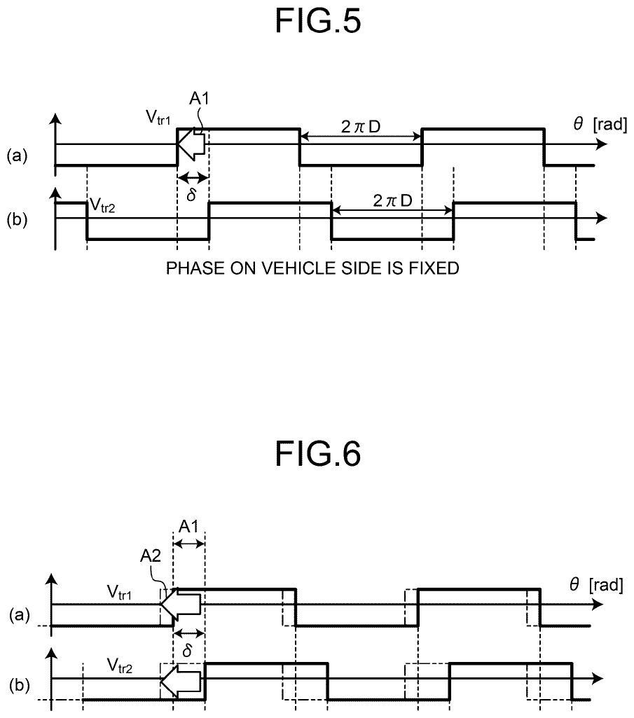

Next, the power control in the non-contact power transmission system 1 is described. FIG. 5 is a diagram illustrating an outline of a conventional power control. FIG. 6 is a diagram illustrating an outline of power control in the non-contact power transmission system 1. In FIGS. 5 and 6, part (a) illustrates the voltage Vtr1 appearing in the ground-side transformer 24, and part (b) illustrates the voltage Vtr2 appearing in the vehicle-side transformer 31.

As illustrated in FIG. 5, conventionally, the ground-side controller 27, by performing the on-off control of the switching element 232 and the switching element 233 of the inverter circuit 23, controls the voltage phase difference δ. Specifically, the ground-side controller 27, when the relay circuit 35 of the power receiving device 3 (vehicle) is released, stops charging by the voltage phase difference δ and 0 by performing the on-off control of the switching element 232 and the switching element 233 of the inverter circuit 23. However, if the abnormality occurs in the vehicle side, if the transmission of the stop instruction via the radio communication, the communication delay due to the wireless communication, the ground-side controller 27 performs on-off control of the switching element 232 and the switching element 233 of the inverter circuit 23, it occurs a delay time from the voltage phase difference δ to 0.

Therefore, as illustrated in FIG. 6, the vehicle-side control device 39, if an abnormality occurs in the vehicle, by controlling the on-off of the switching element 322 and the switching element 323 of the rectifier circuit 32, so that the power receiving device 3 side of the phase by transitioning forward (see arrow A2), controls the voltage phase difference δ to 0. In this case, the vehicle-side control device 39 controls the on-off of the switching element 322 and the switching element 323 of the rectifier circuit 32 so as to be wider than the control range of the voltage phase difference δ of the power receiving device 3 (vehicle-side) (see arrow A1) the control range of the voltage phase difference δ of the power transmission device 2. Thus, without passing through the wireless communication, it is possible to control the voltage phase difference δ, it is possible to stop the power supply power. Furthermore, even when the power transmission device 2 is controlled to further increase the power than the current power by feedback control or the like, it is possible to reliably stop the charging power.

### Processing of Vehicle-Side Control Device

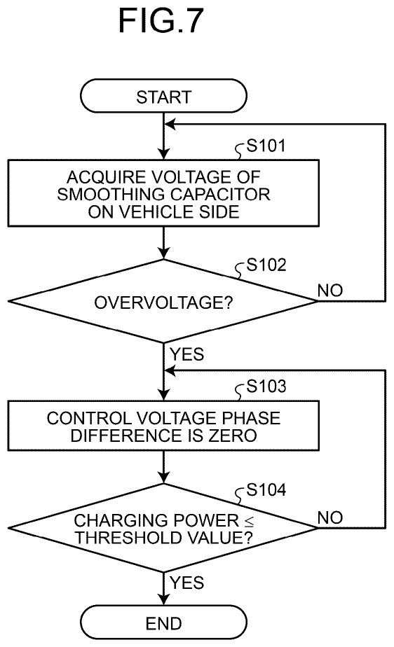

Next, a process in which the vehicle-side control device 39 executes is described. FIG. 7 is a flowchart illustrating an outline of a process that the vehicle-side control device 39 executes. In FIG. 7, the vehicle-side control device 39 will be described one of the processes for starting with the activation of the power transmission device 2 of the non-contact power transmission system 1.

As illustrated in FIG. 7, first, the vehicle-side control device 39 acquires the voltage of the smoothing capacitor 33 of the vehicle side detected by the voltage sensor 34 (step S101).

Subsequently, the vehicle-side control device 39 compares the voltage of the vehicle-side smoothing capacitor 33 acquired from the voltage sensor 34 with a preset threshold value, and determines whether the voltage of the smoothing capacitor 33 is an overvoltage (step S102). Specifically, the vehicle-side control device 39 compares the voltage of the vehicle-side smoothing capacitor 33 acquired from the voltage sensor 34 with a preset threshold value, and when the voltage of the smoothing capacitor 33 is equal to or greater than the threshold value, the voltage of the smoothing capacitor 33 is determined to be an overvoltage. When the vehicle-side control device 39 determines that the voltage of the smoothing capacitor 33 is an overvoltage (step S102: Yes), the vehicle-side control device 39, the process proceeds to step S103. In contrast, when the vehicle-side control device 39 determines that the voltage of the smoothing capacitor 33 is not an overvoltage (step S102: No), the vehicle-side control device 39 returns to step S101.

In step S103, the vehicle-side control device 39 controls the transmission phase differential of the ground-side transformer 24 and the vehicle-side transformer 31 performs on-off control of the switching element 322 and the switching element 323 of the rectifier circuit 32 to 0. Specifically, the vehicle-side control device 39, if an abnormality occurs in the vehicle, by controlling the on-off of the switching element 322 and the switching element 323 of the rectifier circuit 32, by transitioning the phase of the power receiving device 3 side to the front, the voltage phase difference δ It is controlled to 0. In this case, the vehicle-side control device 39 controls the on-off of the switching element 322 and the switching element 323 of the rectifier circuit 32 so as to be wider than the control range of the voltage phase difference δ of the power receiving device 3 (vehicle-side) (see arrow A1) the control range of the voltage phase difference δ of the power transmission device 2.

Subsequently, the vehicle-side control device 39, based on the voltage of the smoothing capacitor 33 of the vehicle side detected by the voltage sensor 34, determines whether the charge power is equal to or less than the threshold (step S104). Specifically, the vehicle-side control device 39, based on the voltage of the smoothing capacitor 33 on the vehicle side of the voltage sensor 34 detects, it is determined whether the charging power becomes 0. The vehicle-side control device 39, based on the voltage of the vehicle-side smoothing capacitor 33 detected by the voltage sensor 34, if the charge power becomes less than the threshold value (step S104: Yes), and ends the process. In contrast, the vehicle-side control device 39, based on the voltage of the vehicle-side smoothing capacitor 33 detected by the voltage sensor 34, if the charge power is not equal to or less than the threshold value (step S104: No), the flow returns to S103 of steps.

According to the first embodiment described above, when the vehicle-side control device 39 overvoltage of the smoothing capacitor 33 is detected by the voltage sensor 34, the voltage phase difference between the ground-side transformer 24 and the vehicle-side transformer 31 since the control to reduce δ, it is possible to stop the charging at the time of abnormality.

Further, according to the first embodiment, since the vehicle-side control device 39 to the voltage phase difference δ between the ground-side transformer 24 and the vehicle-side transformer 31 to 0, without delay at the time of abnormality, it is possible to reliably stop the charging.

Further, according to the first embodiment, since the vehicle-side control device 39 controls the on-off of the switching element 322 and the switching element 323 of the rectifier circuit 32 so as to be wider than the control range of the voltage phase difference δ of the power transmission device 2 of the voltage phase difference δ of the power receiving device 3, the power transmission device 2 by feedback control or the like, even when controlled to further power increase than the current power, it is possible to reliably stop the charging power.

### Second Embodiment

Next, the second embodiment will be described. In the first embodiment, the power was transmitted from the ground side to the vehicle side, but in the second embodiment, the power is transmitted from the vehicle side to the ground side. In the following, a description will be given of the configuration of the non-contact power transmission system of the second embodiment, the processing performed by the non-contact power transmission system. The same reference numerals are given to the same structure as that of the non-contact power transmission system 1 according to the first embodiment, and a detailed description thereof will be omitted.

### Configuration of Contactless Power Transmission System

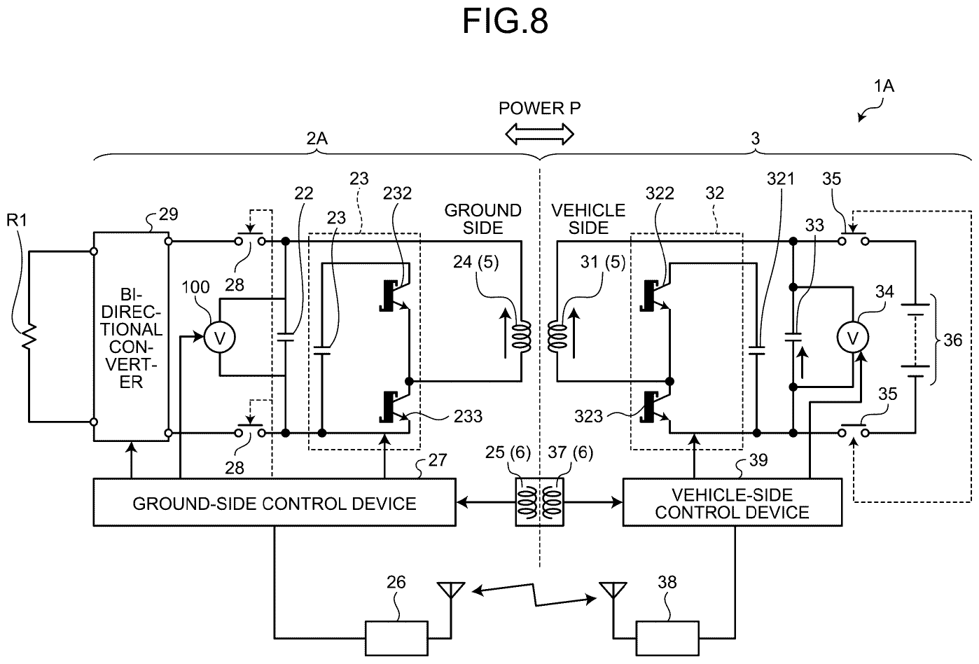

FIG. 8 is a diagram schematically illustrating the configuration of a non-contact power transmission system according to the second embodiment. The non-contact power transmission 1A illustrated in FIG. 8 includes a power transmission device 2A in place of the power transmission device 2 according to the first embodiment.

### Configuration of Power Transmission Device

Next, the configuration of the power transmission device 2A is described. The power transmission device 2A further comprises a relay circuit 28, and the power transmission device 2A further comprises a bi-directional converter 29 and a voltage sensor 100 in place of the PFC circuit 21 according to the first embodiment. In the second embodiment, the power transmission device 2A functions as a non-contact charge control device.

Relay circuit 28 is provided between the bi-directional converter 29 and the inverter circuit 23. The relay circuit 28, under the control of the ground-side controller 27, is turned on (closed state) during charging of the battery 36 of the power receiving device 3 by the power transmission device 2A or discharging of the battery 36 of the power receiving device 3, electrically connecting the bi-directional converter 29 and the inverter circuit 23. In contrast, the relay circuit 35, under the control of the ground-side controller 27, becomes an off state (open state) at the time of charging stop of the battery 36 of the power receiving device 3 by the power transmission device 2A or at the time of discharging stop of the battery 36 of the power receiving device 3, electrically shut off the bi-directional converter 29 and the inverter circuit 23.

The bi-directional converter 29 is electrically connected to the loading R1 and is electrically connected to the inverter circuit 23 via a relay circuit 28. The bi-directional converter 29 functions as an DC power source when the battery 36 of the power receiving device 3 is charged under the control of the ground-side controller 27, and outputs power to the inverter circuit 23. In contrast, the bi-directional converter 29 functions as a DC/AC converter when the battery 36 of the power receiving device 3 is discharged under the control of the ground-side controller 27, converts the direct current inputted from the inverter circuit 23 into alternating current, and outputs it to the load R1.

The voltage sensor 100 detects the voltage of the smoothing capacitor 22 and outputs the detection result to the ground-side controller 27. The voltage sensor 100 is connected in parallel to the smoothing capacitor 22.

### Processing of Ground-Side Control Unit

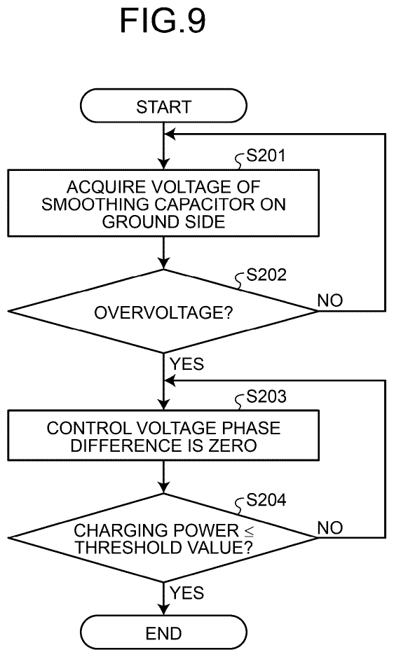

Next, the process performed by the ground-side controller 27 is described. FIG. 9 is a flowchart illustrating an outline of processing that is executed by the ground-side controller 27. In FIG. 9, the vehicle-side control device 39 will be described processing during discharge of the battery 36 of the power receiving device 3.

As illustrated in FIG. 9, first, the ground-side controller 27 acquires the voltage of the ground-side smoothing capacitor 22 detected by the voltage sensor 100 (step S201).

Subsequently, the ground-side controller 27 compares the voltage of the ground-side smoothing capacitor 22 acquired from the voltage sensor 34 with a preset threshold value, and determines whether the voltage of the smoothing capacitor 22 is an overvoltage (step S202). Specifically, the ground-side controller 27 compares the voltage of the ground-side smoothing capacitor 22 acquired from the voltage sensor 100 with a preset threshold value, and, when the voltage of the smoothing capacitor 22 is equal to or greater than the threshold value, the voltage of the smoothing capacitor 22 is determined to be an overvoltage. If the ground-side controller 27 determines that the voltage of the smoothing capacitor 22 is an overvoltage (step S202: Yes), the ground-side controller 27 proceeds to step S203. In contrast, when the ground-side controller 27 determines that the voltage of the smoothing capacitor 22 is not an overvoltage (step S202: No), the ground-side controller 27 returns to the step S201.

In step S203, the ground-side controller 27 controls the transmission phase differential of the ground-side transformer 24 and the vehicle-side transformer 31 by performing on-off control of the switching element 232 and the switching element 233 of the inverter circuit 23 to 0. Specifically, the ground-side controller 27, if an abnormality occurs in the vehicle, by controlling the on-off of the switching element 232 and the switching element 233 of the inverter circuit 23, delaying the phase of the power transmission device 2A later, the voltage phase difference δ It is controlled to 0. In this case, the ground-side controller 27, the control range of the voltage phase difference δ of the power transmission device 2A (ground side), the switching element 232 and the switching element 233 of the inverter circuit 23 so as to be wider than the voltage phase difference δ of the power receiving device 3 (vehicle-side) to control the on-off.

Subsequently, the ground-side controller 27, based on the voltage of the ground-side smoothing capacitor 22 detected by the voltage sensor 100, determines whether the charged power is equal to or less than the threshold value (step S204). Specifically, the ground-side controller 27, based on the voltage of the vehicle-side smoothing capacitor 33 detected by the voltage sensor 34, determines whether the charging power becomes 0. The ground-side controller 27, based on the voltage of the ground-side smoothing capacitor 22 detected by the voltage sensor 100, when the charge power is equal to or less than the threshold value (step S204: Yes), ends the present process. In contrast, the ground-side controller 27, based on the voltage of the ground-side smoothing capacitor 22 detected by the voltage sensor 100, if the charge power is not equal to or less than the threshold value (step S204: No), the flow returns to S203 of steps.

According to the second embodiment described above, when the ground-side controller 27 overvoltage of the smoothing capacitor 22 is detected by the voltage sensor 100, performs control to reduce the voltage phase difference δ between the ground-side transformer 24 and the vehicle-side transformer 31 since, it is possible to stop the charging at an abnormal time.

Further, in the degradation prediction apparatus according to an embodiment, the above-described “control unit” can be read as “control circuit”, and “control device” or the like.

In the description of the flowchart in the present specification, it has been clarified the relationship before and after the processing between the steps using expressions such as “first,” “thereafter,” “following,” etc., the order of the processing necessary for carrying out the present embodiment is not uniquely defined by their expressions. That is, the order of processing in the flowcharts described herein may be varied to the extent that there is no discrepancy.

Further effects and variations can be readily derived by one skilled in the art. The broader aspects of the present disclosure are not limited to the specific details and representative embodiments represented and described above. Accordingly, various changes may be made without departing from the spirit or scope of the overall disclosure concept defined by the appended claims and their equivalents.

While some of the embodiments of the present application have been described in detail based on the drawings, these are illustrative, and it is possible to implement the present disclosure in other forms which are variously modified and improved based on the knowledge of those skilled in the art, starting from the aspects described in the column of the present disclosure.

According to the present disclosure, there is an effect that it is possible to stop charging at an abnormal time.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-contact charging control device for controlling a power receiving device capable of non-contact charging to charge a battery by non-contact receiving power from a power transmission device, the non-contact charging control device comprising:
a transformer of a power receiving side for receiving an AC power having a transmission frequency transmitted from a transformer of a power transmission side in a non-contact manner;
a rectifier circuit for converting the AC power received by the transformer of the power receiving side into DC power and outputting the DC power to the battery;
a smoothing capacitor, provided between the rectifier circuit and the battery, for smoothing a current from the rectifier circuit;
a voltage sensor for detecting a voltage of the smoothing capacitor; and
a controller, when the voltage sensor detects an overvoltage of the smoothing capacitor, reduces a voltage phase difference between the transformer of the power transmission side and the transformer of the power receiving side.

2. The non-contact charging control device according to claim 1, wherein
the controller sets the voltage phase difference between the transformer of the power transmission side and the transformer of the power receiving side to zero.

3. The non-contact charging control device according to claim 2, wherein
the controller controls so that a control range of the voltage phase difference of the transformer of the power receiving side is wider than a control range of the voltage phase difference of the transformer of the power transmission side.

4. The non-contact charging control device according to claim 3, wherein
the rectifier circuit includes a plurality of switching elements, and
the controller performs on-off control on each of the switching elements to reduce the voltage phase difference between the transformer of the power transmission side and the transformer of the power receiving side.

5. The non-contact charging control device according to claim 4, wherein
the non-contact charging control device is provided in a vehicle.
